(19) United States
(12) Patent Application Publication
(10) Pub. No.: US 2005/0064271 A1
(43) Pub. Date: Mar. 24, 2005

(54) Low cost proton exchange membrane fuel cell collector plate

(76) Inventor: Steven Michael Misiaszek, Tequesta, FL (US)

Correspondence Address: Steven M. Misiaszek, 9765 S.E. Landing Place, Tequesta, FL, 33469, US

(21) Appl. No.: 10/944,581

(22) Filed: Sep. 17, 2004

Related U.S. Application Data
(60) Provisional application No. 60/504,491, filed on Sep. 19, 2003.

(51) Int. Cl. H01M 2/14

(52) U.S. Cl. 429/38; 429/39

(57) ABSTRACT

A means for fabricating a low cost collector plate for use in a proton exchange membrane fuel cell. The collector plate consists of a molded plastic core containing the required three dimensional features of the collector plate. The plastic core is coated by electroplating or other means with a metallic coating. This coating resists the corrosive environment within the fuel cell and also provides a conductive path for the electric current produced by the fuel cell reaction.

### CROSS REFERENCE TO RELATED APPLICATIONS

This application claim the benefit of PPA 60/504,491, filed Sep. 19, 2004, by the present inventor.

### FEDERALLY SPONSORED RESEARCH

None.

### SEQUENCE LISTING

None.

### BACKGROUND

This invention relates to the means of fabricating a low cost collector plate for use in a proton exchange membrane fuel cell. Historically proton exchange membrane fuel cell stacks have been designed to maximize power density and useful life. While these attributes are required by some applications, they lead to extremely high cost associated with the materials and labor needed to produce the fuel cell stack. These high performance stacks have application only where their mission enabling capabilities warrant the high cost. There are many applications that are not able to be adequately satisfied by conventional battery technology but could employ a fuel cell of modest cost.

The major cost components of a fuel cell stack are the materials of construction and the labor associated with fabrication and assembly. Obviously, a reduction in the cost of the components and the amount of hands on labor required to produce and assemble them will result in lower stack cost. The major components of the fuel cell stack are the collector or separator plates, the membrane/electrode assembly (MEA), and the hardware needed to compress the plates and MEAs into a sandwich-like structure.

The purpose of the collector plate is to separate the individual cells of a stack, support the MEA, distribute the reactant gases over the surfaces of the MEA and conduct the current produced by the fuel cell reaction. The collector plates currently used in fuel cell stacks are typically of two types: metallic and graphite. The metallic plates can be one piece or assembled from many layers and must be made from a corrosion resistant metal such as stainless steel, nickel alloy, or titanium. The graphite plates can be machined from solid graphite stock or molded from a graphite/polymer mix.

This invention provides for a means of fabricating a collector plate in a novel fashion which requires less expensive materials and less labor than the above mentioned methods.

U.S. Pat. No. 5,798,188 shows a collector plate with an aluminum substrate and a polymer coating that protects the aluminum. Various titanium compounds (or gold or Niobium) are applied to this aluminum/plastic structure to complete the plate.

U.S. Pat. No. 6,451,471 shows a collector plate that is molded of graphite/polymer mix in varying proportions. Certain areas are then machined to expose higher graphite concentration surfaces.

### SUMMARY

This invention, a fabrication method for the manufacture of a proton exchange membrane fuel cell collector plate, provides the means for manufacturing a low cost collector plate for use in applications that require a low cost fuel cell of modest power and endurance. The collector plate is formed by fabricating an injection molded core which contains the required features of the collector plate: frame, manifolds, gas flow pathways, sealing structures, assembly structures, etc. This plastic core is then plated with a corrosion resistant, conductive metal coating, such as nickel. Such a coating would conduct the electric current produced by the fuel cell reaction, resist the corrosive environment within the fuel cell and meet the low cost requirement.

### DRAWINGS

FIG. 1 is a view of the anode side of a typical collector plate.

FIG. 2 is a view of the cathode side of a typical collector plate.

FIG. 3 presents a sectional view of the collector plate.

### DETAILED DESCRIPTION

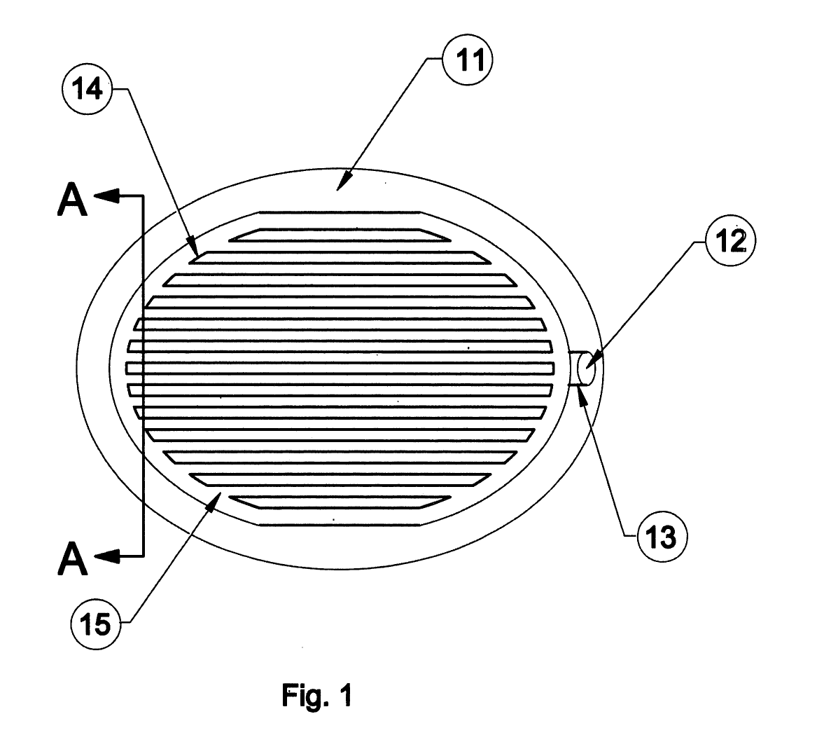

FIG. 1 is a view of the anode side of a collector plate showing the typical features; the collector plate frame 11, anode gas manifold 12, anode gas inlet manifold 13, anode gas flow field ridge 14 (typical) and anode gas flow field valley 15 (typical).

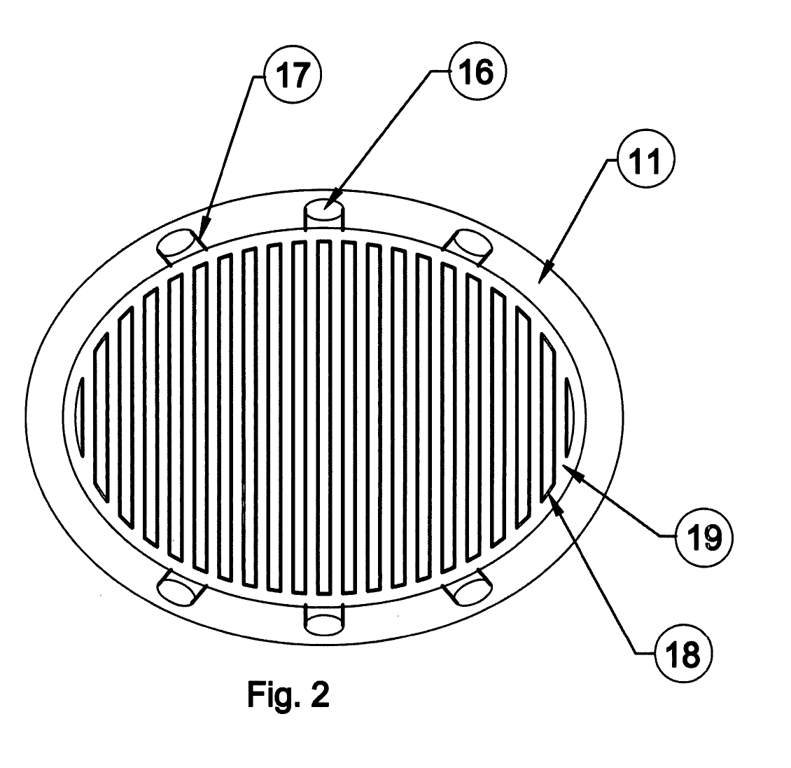

FIG. 2 is a view of the cathode side of a collector plate. The features of the cathode side of the plate are similar to those of the anode side with the possible exception of the number and location of the manifolds and the orientation of the flow field. The plate features include frame 11, cathode gas manifold 16 (typical), cathode gas inlet manifold 17 (typical), cathode gas flow field ridge 18 (typical), cathode gas flow field valley 19 (typical).

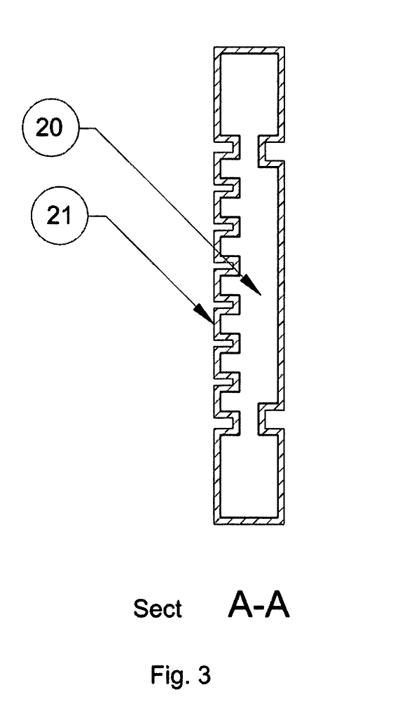

FIG. 3 presents a sectional view of the collector plate. Section A-A shows the collector plate plastic core with features 20, and the collector plate metallic coating 21.

Reference Numerals

11 Collector plate frame
12 Anode gas manifold
13 Anode gas inlet manifold
14 Anode gas flow field ridge
15 Anode gas flow field valley
16 Cathode gas manifold
17 Cathode gas inlet manifold
18 Cathode gas flow field ridge
19 Cathode gas flow field valley
20 Collector plate plastic core with features
21 Collector plate metallic coating

### ALTERNATIVE EMBODIMENT

An alternative embodiment of this invention would consist of a stamped plastic core with the required collector plate features and a metallic coating.

An alternative embodiment of this invention would consist of the metallic coating being applied by sputtering or other deposition means.

An alternative embodiment of this invention would consist of the metallic coating being an alloy not containing nickel.

Operation

The fabrication means described in this invention first requires that an injection mold be constructed which contains most or all of the three dimensional features of the collector plate. Such features as inlet manifolds may be drilled or machined into the collector plate after molding. In order to reduce cost, post-molding alteration of the part should be kept to a minimum.

Once the mold is completed, a suitable engineering plastic compound is selected for use in molding the collector plate. The most important selection requirements for the plastic molding compound are dimensional stability, modest heat resistance, and low cost.

Collector plate cores can then be injection molded using the mold and plastic molding compound. Any post-molding machining is also completed on the finished collector plate cores.

The collector plate cores are then cleaned, if required, and plated with a nickel or nickel alloy coating. The coating thickness will vary with the alloy selected and the intended electrical current the fuel cell stack will produce. The coating must have a minimal thickness to completely cover the plastic core.

The coated plate is now ready for incorporation into a fuel cell stack.

1. A low cost collector plate for use in a proton exchange membrane fuel cell, comprising:
a. a molded plastic core containing the required three dimensional, collector plate features,
b. an applied, electrically conductive, corrosion resistant, metal coating, whereby the functionality of traditional collector plate design is achieved, the fabrication time and labor is decreased, and the cost of the fabrication materials is reduced.

2. The plastic core of claim 1 may be stamped instead of molded.
